(19) United States
(12) Patent Application Publication
(10) Pub. No.: US 2006/0060024 A1
(43) Pub. Date: Mar. 23, 2006

(54) Latching system for storage bin

(76) Inventor: Jason Parkerson, Mansfield, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/201,588

(22) Filed: Aug. 11, 2005

Related U.S. Application Data
(60) Provisional application No. 60/600,982, filed on Aug. 12, 2004.

(51) Int. Cl. F16H 53/00

(52) U.S. Cl. 74/567

(57) ABSTRACT

A roller cam latching system adapted for securing a door of a storage bin for handling bulk materials includes a roller cam assembly and a latch assembly. The roller cam assembly includes a post and a bushing such that the bushing is rotatably disposed about the post. The latch assembly includes a contact member defining a contact surface and an actuator affixed to the contact member which can actuate the contact member between a first and a second position. In operation, actuation of the contact member from the first position to the second position causes the contact surface of the contact member to engage the bushing to secure the door of the storage bin.

### CROSS-REFERENCE TO RELATED APPLICATIONS

This application is related to and claims priority from U.S. Provisional Application Ser. No. 60/600,982 filed Aug. 12, 2004, and entitled “Roller Cam Assembly for Side Door Bin”, and is hereby incorporated by reference.

### BACKGROUND

The present invention relates generally to a latching system for a storage bin. More particularly, the present invention relates to a roller cam assembly and roller cam latching system promoting improved storage bin door lockdown.

Storage bins are a well-known means for handling bulk materials such as pharmaceuticals, foods, plastics, chemicals, and others. Typically, such bins are made from stainless steel or other appropriate materials. These bins generally include some type of door, hinged or otherwise. One common method of maintaining door closure is through use of a latch dog assembly. While use of latch dogs is generally well known, improvements remain to be made in both ease of use and functionality.

### SUMMARY

One aspect of the present invention relates to a roller cam latching system adapted for securing a door of a storage bin for handling bulk materials. The roller cam latching system includes a roller cam assembly including a post and a bushing rotatably disposed about the post, and a latch assembly including a contact member defining a contact surface and an actuator affixed to the contact member for actuating the contact member between a first position and a second position. As such, the contact surface of the contact member engages the bushing upon actuation of the contact member from the first position to the second position.

One aspect of the present invention relates to a roller cam latching system. The roller cam latching system includes a roller cam assembly including a post defining a substantially cylindrical shape and a bushing rotatably disposed about at least a portion of the post, and a latch assembly including a propeller having a sidewall defining a helical contact surface, a shaft defining a first end and a second end, with the first end secured to the propeller, and an actuation member secured to the second end of the shaft such that actuation of the actuation member rotates the propeller. As such, the latch assembly and the roller cam assembly are configured such that rotating the propeller engages the bushing with the helical contact surface to produce rotation of the bushing and a resultant closing force on the latch assembly.

One aspect of the present invention relates to a roller cam assembly for securing a door of a storage bin. The roller cam assembly includes a post affixed to the storage bin and a bushing rotatably disposed on the post. The post includes a substantially cylindrical head having a top end and a bottom end, and a neck formed at the bottom end of the head, with the neck defining a diameter less than that of the head. The bushing includes an upper body defining a tubular shape and extending from a bottom end to a top end, and a retaining collar formed at the bottom end of the upper body, with the retaining collar defining an inner diameter less than that of the upper body of the bushing. As such, the retaining collar of the bushing interacts with the neck of the post to retain the bushing on the post.

One aspect of the present invention relates to a storage bin for handling bulk materials. The storage bin includes a body defining an enclosure and an access opening to the enclosure, a door openably secured to the body over the access opening, a roller cam assembly secured to the body, and a latch assembly secured to the door. The roller cam assembly includes a post and a bushing rotatably disposed about the post, and the latch assembly includes a contact member and an actuator affixed to the contact member. The actuator is configured to actuate the contact member from a first position to a second position to engage the bushing of the roller cam assembly with the contact member. As such, the door is secured in a closed position over the access opening upon actuation of the contact member from the first position to the second position.

### BRIEF DESCRIPTION OF THE DRAWINGS

FIG. 1 is an isometric view of an exemplary side door bin in accordance with the present invention.

FIGS. 2A, 2B, and 2C are views of the exemplary side door bin of FIG. 1.

FIG. 3 is a side, cross-sectional view through line 3-3 of FIG. 2A of an exemplary hinge mechanism of the side door bin.

FIG. 4 is a side, cross-sectional view through line 4-4 of FIG. 2A of an exemplary roller cam latching system in accordance with the present invention.

FIG. 5 is a cross-sectional view through a central axis of a post of the roller cam latching system of FIG. 4.

FIG. 5A is a detail view as indicated in FIG. 5.

FIG. 6 is a cross-sectional view through a central axis of a bushing of the roller cam latching system of FIG. 4.

FIG. 6A is a detail view as indicated in FIG. 6.

FIG. 7 is an exploded and perspective view of an exemplary roller cam assembly in accordance with the present invention.

FIG. 8 is a cross-sectional view through a central axis of an exemplary roller cam assembly in accordance with the present invention.

### DETAILED DESCRIPTION

In the following Detailed Description, reference is made to the accompanying figures, which form a part hereof, and in which is shown by way of illustration specific embodiments in which the invention may be practiced. In this regard, directional terminology, such as “top,” “bottom,” “front,” “back,” “left”, “right,” etc., is used with reference to the orientation of the Figure(s) being described. Because components of the embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

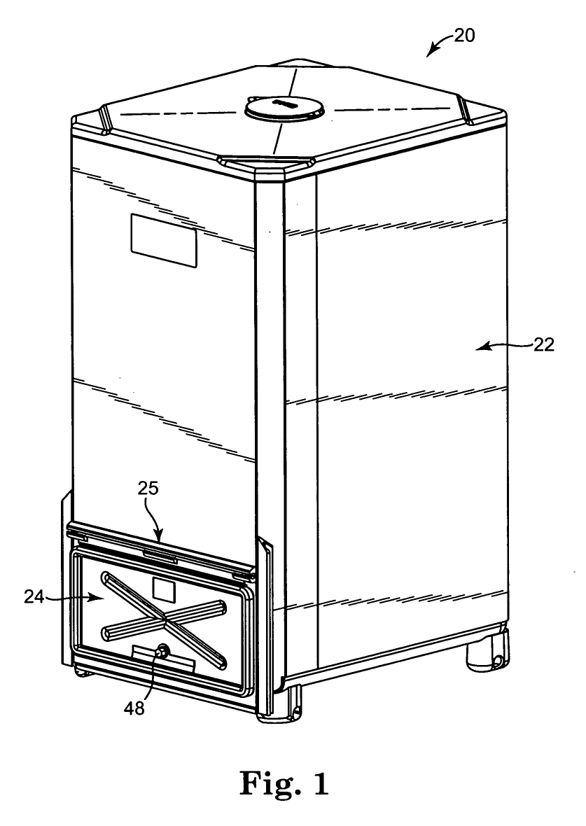

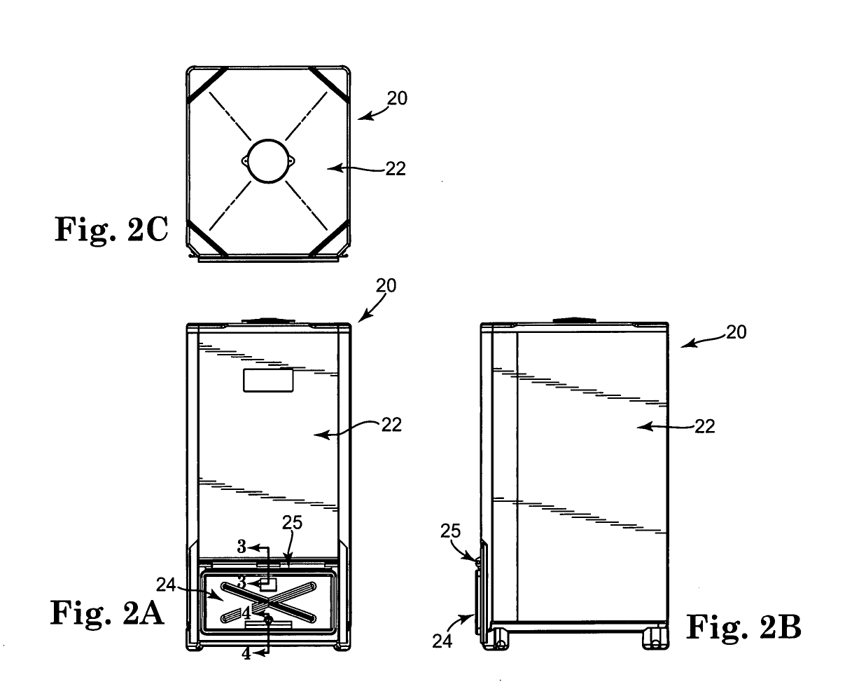

FIGS. 1, 2A, 2B, and 2C illustrate an exemplary, side door bin 20 as one example of a storage bin in accordance with the present invention. The side door bin 20 generally includes a body 22 defining an enclosure and a door, such as a side door 24. As shown, the side door 24 is openably secured via a hinge 25 over an access opening (hidden) formed in a lower portion of the body 22. As shown, the side door 24 covers the access opening.

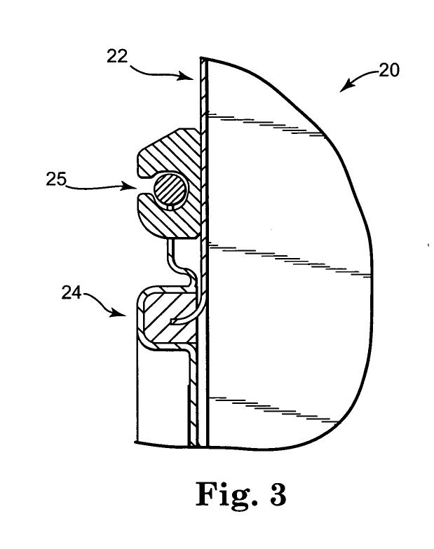

With reference to FIG. 3, an exemplary embodiment of the hinge 25 is shown in greater detail. As shown, the hinge 25 is configured to facilitate secure closure of the side door 24 to the body 22.

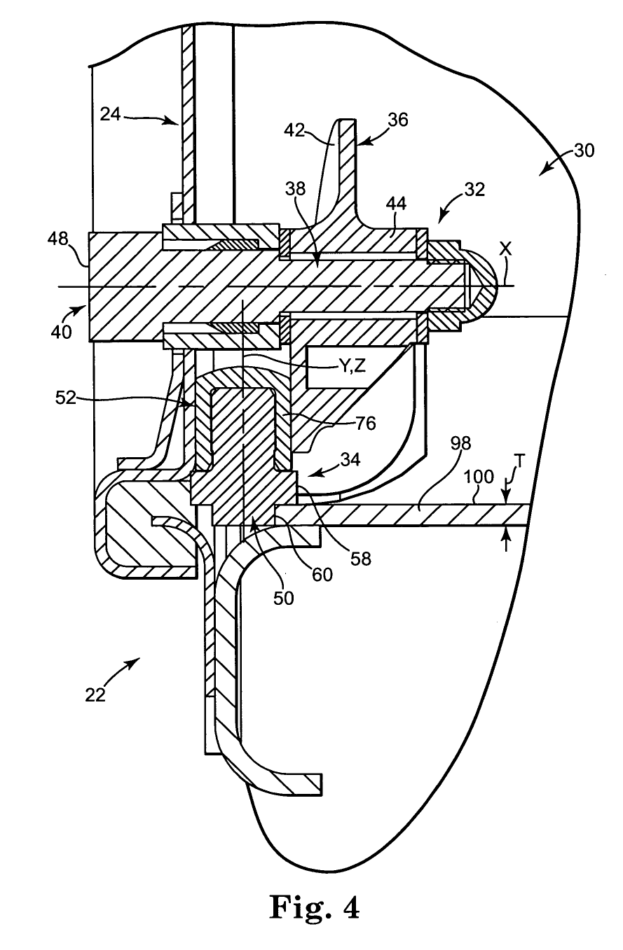

With reference to FIG. 4, an exemplary embodiment of a roller cam latching system 30 in accordance with the present invention can be described. Generally, the roller cam latching system 30 includes a latch assembly, such as a propeller assembly 32, as well as a roller cam assembly 34. More specifically, the latch assembly, or the propeller assembly 32, defines a central axis X and includes a contact member, such as a propeller 36, a shaft 38, and an actuation member 40.

The propeller 36 includes a helical wall 42 radially extending partially about a cylindrical body 44 of the propeller 36. As will be understood in greater detail below, the helical wall 42 defines a contact surface for engaging the roller cam assembly 34. Depending upon the application, the propeller assembly 32, including the propeller 36, can be made of a variety of materials including, for example, aluminum 6061.

The shaft 38 is generally cylindrical and configured such that the shaft 38 can be rotationally fixed relative to the propeller 36. Further, the shaft 38 is configured to be fixed relative to the side door 24 in both a direction parallel to the central axis X and in a direction transverse to the central axis X of the propeller assembly 32.

The actuation member 40 is configured to interact with the shaft 38 and the propeller 36, such that rotation of the propeller 36, and in particular, the helical wall 42, can be accomplished as desired by actuating the actuation member 40. In this manner, the propeller 36 can be actuated between a first, open position and a second, closed position. In one embodiment, the actuation member 40 includes a hex head cap 48 fixed rotationally relative to the shaft 38 and consequently, the propeller 36. Thus, actuating the actuation member 40 includes rotation of the hex head cap 48. In particular, rotation of the hex head cap 48 results in concurrent rotation of the propeller 36, including the helical wall 42. For further reference, the hex head cap 48 is shown in more detail in FIG. 1.

While one exemplary embodiment of the latch assembly 32 has been generally described above, it is to be recognized that a variety of alternatively designed latch assemblies can be utilized without departing from the scope of the present invention. For example, other actuation arrangements such as electric motors, levers, or gears, could be employed within alternative embodiments of the latch assembly 32 without departing from the scope of the present invention.

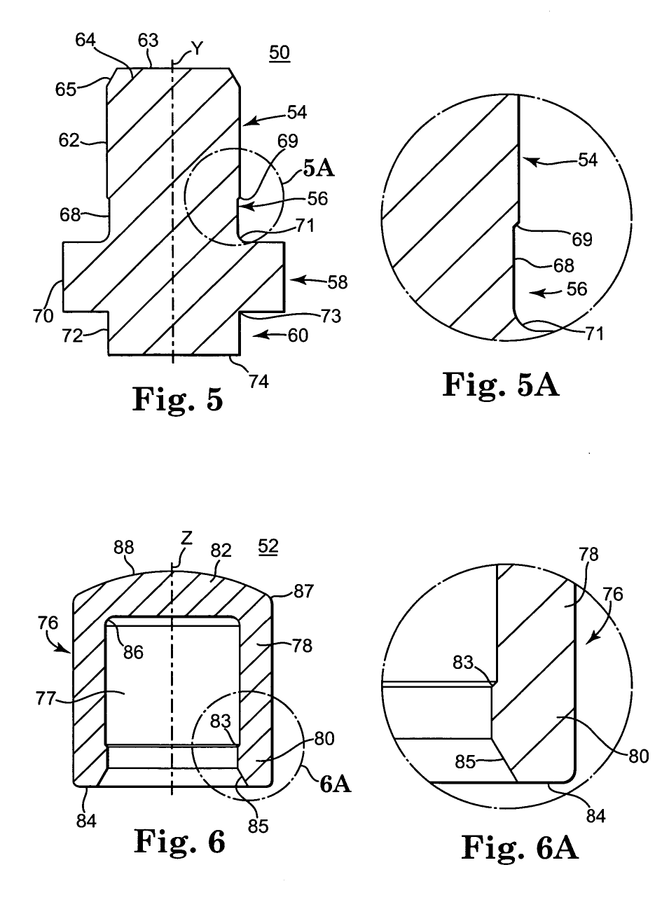

With additional reference to FIG. 4, an exemplary embodiment of the roller cam assembly 34 can be described. Generally, the roller cam assembly 34 includes a post 50 and a bushing 52. With reference to FIGS. 5 and 5A, it can be understood that the post 50 can be solid and continuously formed from a material such as aluminum 6061. As shown, the post 50 includes a post head 54, a post neck 56, a post body 58, and a post base 60 and defines a central axis Y.

In one embodiment shown in FIG. 5, the post head 54 forms a solid cylinder including a generally vertical head sidewall 62 terminating at a top end or face 63 of the post 50. In one exemplary embodiment, the head sidewall 62 defines a height of approximately 0.74 inches and a diameter of approximately 0.75 inches. Furthermore, the post head 54 terminates at a crown 64 characterized by a chamfer 65. In one exemplary embodiment, chamfer 65 defines an angle of approximately 60 degrees from horizontal. Furthermore, in one exemplary embodiment, the crown 64 is chamfered to a diameter smaller than the diameter of the head sidewall 62 by approximately 0.12 inches.

In one embodiment, the post neck 56 forms a solid cylinder including a vertical neck sidewall 68 having a diameter less than that of the head sidewall 62. In one exemplary embodiment, the neck sidewall 68 has a diameter of approximately 0.725 inches and extends a height of approximately 0.26 inches. The post neck 56 is coaxially aligned to and integrally formed with the post head 54 at a bottom end of the post head 54 opposite the top face 63. Furthermore, in one exemplary embodiment, the connection, or transition, between the post neck and the post head 54 defines a chamfer 69 at an angle of approximately 45 degrees.

In one embodiment, the post body 58 forms a solid cylinder including a vertical body sidewall 70 having a diameter greater than the post neck 56, or in another embodiment, the post head 54. In one exemplary embodiment, the body sidewall 70 defines a diameter of approximately 1.25 inches and a height of approximately 0.4 inches. As shown, the post body 58 is coaxially aligned with, and integrally formed with the post neck 56. The connection between the post body 58 and the post neck 56 can define a round 71. In one exemplary embodiment, the round 71 has a radius of approximately 0.06 inches.

In one embodiment, the post base 60 forms a solid cylinder including a substantially vertical base sidewall 72 having a diameter smaller than that of the post body 58. As shown, the base sidewall 72 originates at a bottom face 74 of the post 50. As shown in FIG. 4, the base sidewall 72 can define a length generally corresponding to a thickness T of the body 22 of the side door bin 20. In one exemplary embodiment, the base sidewall 72 has a diameter of approximately 0.74 inches and a height of approximately 0.25 inches. As shown, the post base 60 is coaxially aligned with the body 58 and connected thereto. The connection between the post base 60 and the body 58 can form a corner 73. In one exemplary embodiment, the corner 73 forms an approximately 90-degree angle.

With reference to FIGS. 6 and 6A, an exemplary embodiment of the bushing 52 can be described in greater detail. Generally, the bushing 52 defines a tubular shape and includes a substantially vertical sidewall 76 forming an inner cavity 77 and defining an upper body 78 and a retaining collar 80, and includes a cap 82. In one exemplary embodiment, the bushing 52 defines an overall height of approximately 1.188 inches, a retaining collar height of approximately 0.166 inches, an inner diameter of approximately 0.765 inches, and an outer diameter of approximately 1.125 inches. The bushing 52 can be formed from a variety of wear materials including polymeric or metallic materials. In one exemplary embodiment, the bushing 52 is formed of Hydex 4101.

In one embodiment, the bushing sidewall 76 continuously forms the retaining collar 80 at a bottom end of the upper body 78. The retaining collar 80 defines an outer diameter substantially the same as that of the upper body 78, but defines an inner diameter less than that of the upper body 78. The inner diameter of the upper body 78 can transition to the inner diameter of the retaining collar 80 to define a chamfer 83. In one exemplary embodiment, the transition is over a height of approximately 0.12 inches. The chamfer 83 can generally match the dimensions, e.g., the angle and a length, defined by the chamfer 69 of the post 50. In one exemplary embodiment, the chamfer 83 is at an angle of approximately 45 degrees and an inner diameter of the retaining collar 80 is approximately 0.74 inches.

Additionally, the inner diameter of the retaining collar 80 can transition to an inner diameter of a terminal end 84 of the retaining collar 80 to define a chamfer 85. The chamfer 85 and the chamfer 65, and the other chamfers of the post 50 and the bushing 52 can be configured to interact to facilitate positioning of the bushing 52 over the post 50, to facilitate removal of the bushing 52 from the post 50, or to prevent the bushing 52 from inadvertently coming off of the post 50. In one respect, the chamfer 85 can generally match the chamfer 65 of the post 50. In relative terms, the matching chamfers 65,85 are steeper than matching chamfers 69,83. In one embodiment, the matching chamfers 65,85 are formed at a relatively steep angle to facilitate installation of the bushing 52 over the post 50. Conversely, the matching chamfers 69,83 are at a less steep angle to reduce the chance of accidental, or otherwise unwanted removal of the bushing 52 from the post 50. In one exemplary embodiment, the inner diameter at the terminal end 84 is less than the inner diameter of the retaining collar 80 such that the chamfer 85 defines an angle of approximately 60 degrees from the horizontal.

In one embodiment, a top end of the bushing 52 is topped with a cap 82 that is continuously formed with the upper body 78 and at an opposing end to the retaining collar 80. The cap 82 can transition from the upper body 78 to define an internal round 86. In one exemplary embodiment, the round 86 defines a radius of approximately 0.06 inches.

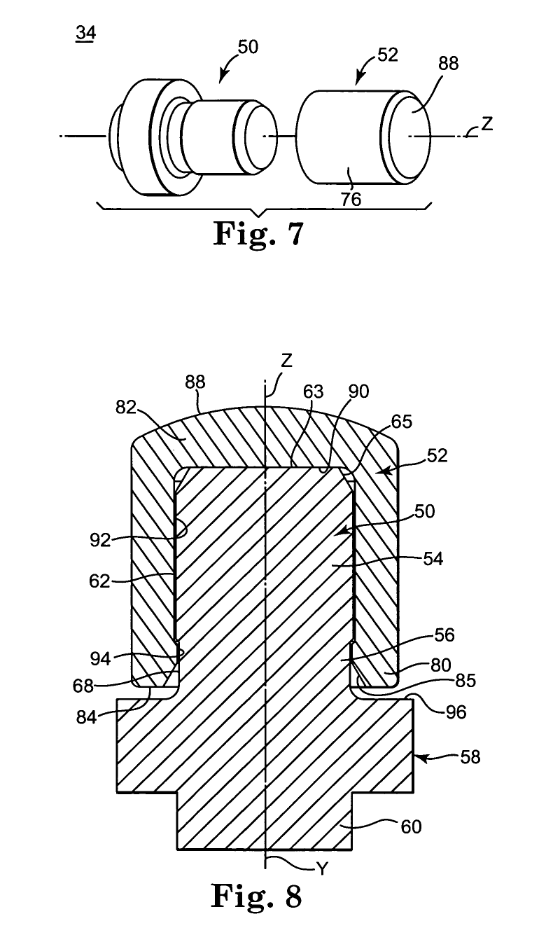

In one embodiment, the cap 82 defines a top surface 88 of the bushing 52. In one exemplary embodiment, the top surface 88 is generally dome-shaped defining a radius of curvature of approximately 1.125 inches. However, the top surface 88 can also be generally flat as can be better understood with reference to FIG. 7. The top surface 88 transitions to the sidewall upper body 78 to define an external chamfer 87. In one exemplary embodiment, the external chamfer 87 is at an angle of approximately 45 degrees. In another exemplary embodiment, the external chamfer 87 is alternatively a round 87 having a radius of approximately 0.19 inches.

While exemplary embodiments, including dimensions thereof, have been described herein, it is to be generally understood that the bushing 52 is configured to be rotatably disposed about the post head 54 and post neck 56. Furthermore, the bushing 52 and post 50 are manufactured in such a manner that the bushing 52 is removable from the post 50 without damage to the post 50 or the bushing 52.

FIG. 7 shows one exemplary embodiment of the post 50 and the bushing 52 prior to assembly. In one embodiment, the bushing 52 is positionable over and removable from the post 50, as the sidewall 76 of the bushing 52 is at least somewhat flexible and can be deflected outwardly relative to the central axis Z of the bushing 52.

As shown in FIG. 8, when the bushing 52 is positioned over the post 50, the retaining collar 80 is configured to interact in a complementary fit with the post neck 56. Thus, in one embodiment, a flexible property of the bushing 52 permits the retaining collar 80 to be deflected outwardly away from the central axis Z of the bushing 52, or alternatively central axis Y of the post 50, in order to secure the bushing 52 about the post head 54 and the post neck 56. In this manner, the bushing 52 can be removed from the post head 54 and the post neck 56. In other words, the semi-flexible configuration of the bushing 52 results in a roller cam assembly 34 with the bushing 52 being removably secured to the post 50.

Furthermore, the chamfer 85 of the bushing 52 is suited to facilitate removal and replacement of the bushing 52 on the post 50. As alluded to above, the chamfer 85 can help guide the retaining collar 80 away from the central axis Z of the bushing 52 when it is being maneuvered onto the post 50. For example, as described above, the chamfer 85 and the chamfer 65 can act in a complementary manner to facilitate assembly of the bushing 52 over the post 50.

The bushing 52 is also configured to rotate about the cylindrical head 54 and the post neck 56 of the post 50. In particular, selective and/or slidable contact exists between the bushing 52 and the post 50. In one embodiment, an inner surface 90 of the cap 82 slidably contacts the top face 63 of the post head 54. Additionally, an inner face 92 of the bushing sidewall 76 slidably contacts the post head sidewall 62. In this respect, an inner face 94 of the retaining collar 80 also slidably contacts the post neck sidewall 68.

In one embodiment, the terminal end 84 of the bushing 52 is maintained apart from a body top face 96 of the post body 58. In this respect, a space between the body top face 96 and the terminal end 84 can be such that a removal tool can be inserted between them. In another embodiment, the bushing 52 can be moved, or lifted, relative to the post 50, such that a sufficient space for a removal tool is maintained between the body top face 96 and the terminal end 84. In one exemplary embodiment, the space is approximately 0.08 inches. In yet another embodiment, the terminal end 84 of the bushing 52 slidably contacts the body top face 96 of the post body 58.

As indicated above, while certain embodiments include the slidably contacting interactions described above, it should be noted that the embodiments can include selective, slidable contact, or even no contact at all between the surfaces described above. For example, the inner surface 90 of the bushing cap 82 can be separated from the top face 63 of the post 50. Furthermore, the bushing 52 need not completely enclose the post head 54 and post neck 56. For example, holes or other features, such as those used to introduce lubrication between surfaces could be incorporated into the bushing 52.

With reference to FIG. 4, interaction between the propeller assembly 32 and the roller cam assembly 34 can be further described. As shown, the roller cam assembly 34 is affixed to an internal surface 98 of the enclosed body 22 of the side door bin 20 proximate the latch assembly 32, or the propeller assembly 32. In particular, the post base 60 of the post 50 is disposed within the internal surface 98 of the side door bin 20 such that the post body 58 abuts a top face 100 of the internal surface 98.

In one embodiment, the post 50 is fixed relative to the internal surface 98. One method of assembling the post 50 with the internal surface 98 includes: drilling a hole in the internal surface 98; inserting the post base 60 into the hole; and welding the post 50 to the internal surface 98. In one exemplary embodiment, the hole is approximately 0.75 inches in diameter. The post body 58 and/or post base 60 can be welded to the internal surface 98. In one embodiment, welding the post 50 to the internal surface 98 includes welding a fillet weld at the vertical body sidewall 70 and a portion of the surface 98 proximate the vertical body sidewall 70. In another embodiment, the post 50 includes threads (not shown) such that the post 50 is screwed into the internal surface 98. However, and as mentioned above, the bushing 52 remains free to rotate about the central axis Y, or alternatively the central axis Z, of the post 50 and the bushing 52, respectively.

In one embodiment described above, the propeller assembly 32 is fixed to the side door 24 in both a transverse and axial direction relative to the central axis X. Additionally, the propeller assembly 32 is affixed to the side door 24 such that when the side door 24 is in a closed position (as shown) the helical wall 42 of the propeller 36 can contact the bushing sidewall 76 to “pull” the side door 24 tightly closed as the propeller 36 and more specifically, the helical wall 42, is rotated. In other words, rotation of the helical wall 42 induces a resultant thrust, or closing, force on the roller cam assembly 34, thus closing the side door 24.

With this arrangement, the helical wall 42 can be moved past the post 50 when the side door 24 is first closed. The propeller 36 can then be rotated via the actuation member 40 such that the helical wall 42 exerts a tangential force on the sidewall 76 of the bushing 52, as well as an accompanying thrust force. In one embodiment, the bushing 52 rotates about the post 50 in response to the tangential force applied to the sidewall 76. Rotation of the bushing 52 about the post 50 reduces the friction between the roller cam assembly 34 and the propeller assembly 32. This reduction in friction, in turn, reduces torque necessary to rotate the helical wall 42 and, therefore, the propeller assembly 32. The resultant thrust force from contact between the helical wall 42 and the roller cam assembly 34 causes the side door 24 to tighten against the body 22 as the propeller 36 is progressively rotated against the bushing sidewall 76.

The capability of the bushing 52 to rotate about the post 50 is advantageous for several reasons. As mentioned, rotation of the bushing 52 decreases the torque needed to rotate the propeller 36 against the roller cam assembly 34. Additionally, wear on both the propeller 36 and, in particular, the helical wall 42, is reduced. Furthermore, corresponding wear on the post 50 that would occur in the absence of the bushing 52 is either eliminated or reduced. The bushing 52 can also be readily replaced after substantial wear has occurred, as the bushing 52 is removably secured to the post 50 as described above. Exemplary embodiments of the bushing 52 are also conducive to an operator using a screwdriver, for example, to simply “pop” the bushing 52 off of the post 50, thus reducing otherwise wasteful bushing/post change-out times. In light of the above discussion and accompanying figures, the present invention supplies a roller cam assembly and roller cam latching system promoting improved side door lock down.

Although specific embodiments have been illustrated and described herein, it will be appreciated by those of ordinary skill in the art that a variety of alternate and/or equivalent implementations may be substituted for the specific embodiments shown and described without departing from the scope of the present invention. With that in mind, this application is intended to cover any adaptations or variations of the specific embodiments discussed herein.

What is claimed is:

1. A roller cam latching system adapted for securing a door of a storage bin for handling bulk materials, the roller cam latching system comprising:
a roller cam assembly including,
a post, and
a bushing rotatably disposed about the post; and
a latch assembly including,
a contact member defining a contact surface, and
an actuator affixed to the contact member for actuating the contact member between a first position and a second position;
wherein the contact surface of the contact member engages the bushing upon actuation of the contact member from the first position to the second position.

2. The system of claim 1, wherein the roller cam assembly is secured to the storage bin and the latch assembly is secured to the door, and further wherein the roller cam assembly and the latch assembly are configured such that engaging the bushing with the contact member secures the door of the storage bin.

3. The system of claim 1, wherein the contact member of the latch assembly includes a helical wall, the helical wall defining the contact surface, and further wherein the actuator is configured to rotate the helical wall.

4. The system of claim 1, wherein the post of the roller cam assembly defines a cylindrical body and the bushing of the roller cam assembly defines a cavity, at least a portion of the cylindrical body disposed within the cavity.

5. The system of claim 4, wherein the bushing covers at least a portion of the cylindrical body of the post.

6. The system of claim 1, wherein the bushing is removably disposed about the post.

7. A roller cam latching system, comprising:
a roller cam assembly including,
a post defining a substantially cylindrical shape, and
a bushing rotatably disposed about at least a portion of the post;
a latch assembly including,
a propeller having a sidewall defining a helical contact surface,
a shaft defining a first end and a second end, the first end secured to the propeller, and
an actuation member secured to the second end of the shaft, wherein actuation of the actuation member rotates the propeller; and
wherein the latch assembly and the roller cam assembly are configured such that rotating the propeller engages the bushing with the helical contact surface to produce rotation of the bushing and a resultant closing force on the latch assembly.

8. The system of claim 7, wherein the bushing of the roller cam assembly defines an inner cavity and comprises:
an upper body defining a tubular shape having an inner diameter and an outer diameter and extending from a bottom end to a top end; and
a retaining collar formed at the bottom end of the tubular body, the retaining collar defining an inner diameter less than the inner diameter of the upper body.

9. The system of claim 8, wherein a transition between the inner diameter of the upper body and the inner diameter of the retaining collar includes a chamfer configured to facilitate removal of the bushing from the post.

10. The system of claim 8, wherein a bottom portion of the retaining collar includes a chamfer from the inner diameter of the retaining collar to a bottom face of the retaining collar, the chamfer configured to facilitate positioning of the bushing over the post.

11. The system of claim 8, wherein the post of the roller cam assembly comprises:
a head having a cylindrical shape, the head defining a diameter and extending from a top end to a bottom end; and
a neck formed at the bottom end of the head, the neck defining a diameter smaller than the diameter of the head, wherein the diameter of the neck is such that the retaining collar of the bushing engages the neck of the post to secure the bushing on the post.

12. The system of claim 11, wherein a transition from the diameter of the neck to the diameter of the head includes a chamfer configured to facilitate removal of the bushing from the post.

13. The system of claim 11, wherein the post of the roller cam assembly further comprises:
a crown formed at the top end of the head, the crown defining a chamfer from a diameter of the top end of the head to a top of the crown, the chamfer configured to facilitate installation of the bushing over the post.

14. The system of claim 7, wherein at least a portion of the bushing is substantially flexible to allow both positioning of the bushing on the post and removal of the bushing from the post without damage to the bushing or the post.

15. A roller cam assembly for securing a door of a storage bin, the roller cam assembly comprising:
a post affixed to the storage bin, the post including,
a substantially cylindrical head having a top end and a bottom end; and
a neck formed at the bottom end of the head, the neck defining a diameter less than that of the head;
a bushing rotatably disposed on the post, the bushing including,
an upper body defining a tubular shape and extending from a bottom end to a top end, and
a retaining collar formed at the bottom end of the upper body, the retaining collar defining an inner diameter less than that of the upper body of the bushing; and
wherein the retaining collar of the bushing interacts with the neck of the post to retain the bushing on the post.

16. The assembly of claim 15, wherein a transition from the neck of the post to the head of the post defines a first chamfer, and further wherein a transition from the upper body of the bushing to the retaining collar of the bushing defines a second chamfer, wherein the first and the second chamfers interact to facilitate removal of the bushing from the post.

17. The assembly of claim 15, wherein the top end of the head of the post defines a first chamfer and a bottom portion of the retaining collar defines a second chamfer, wherein the first and second chamfers facilitate installation of the bushing on the post.

18. A storage bin for handling bulk materials, the storage bin comprising:
a body defining an enclosure and an access opening to the enclosure;
a door openably secured to the body over the access opening;
a roller cam assembly secured to the body, the roller cam assembly including,
a post, and
a bushing rotatably disposed about the post;
a latch assembly secured to the door, the latch assembly including,
a contact member, and
an actuator affixed to the contact member and configured to actuate the contact member from a first position to a second position to engage the bushing of the roller cam assembly with the contact member; and
wherein the door is secured in a closed position over the access opening upon actuation of the contact member from the first position to the second position.

19. The storage bin of claim 18, wherein the contact member of the latch assembly includes a propeller rotatably secured to the door, wherein actuation of the actuator causes rotation of the propeller from the first position to the second position.

20. The storage bin of claim 18, wherein actuation of the contact member to engage the bushing results in a rotation of the bushing and a closing force on the roller cam assembly.
